(19) United States
(12) Patent Application Publication
(10) Pub. No.: US 2010/0138241 A1
(43) Pub. Date: Jun. 3, 2010

(54) System and Method for Computerized Medical Records Review

(76) Inventors: William Marcus Ruark, Austin, TX (US); Daniel L. Camacho, Neenah, WI (US)

Correspondence Address: Andrews Kurth LLP, 111 Congress Avenue, Suite 1700, Austin, TX, 78701, US

(21) Appl. No.: 12/626,590

(22) Filed: Nov. 25, 2009

Related U.S. Application Data
(60) Provisional application No. 61/117,954, filed on Nov. 25, 2008.

(51) Int. Cl. G06Q 50/00; G06Q 10/00

(52) U.S. Cl. 705/3

(57) ABSTRACT

A system and method for computerized medical records review are provided. A draft diagnostic report is reviewed by a computerized draft analyzer for report inadequacies, including inadequate information to support reimbursement for diagnostic studies described in the diagnostic report. The review may also encompass other electronic medical records. Any inadequacies identified by the draft analyzer are flagged for correction prior to finalization of the draft diagnostic report.

### PRIORITY CLAIM

This application claims the benefit of U.S. Provisional Patent Application No. 61/117,954, filed on Nov. 25, 2008, the contents of which are incorporated by reference in full for all purposes.

### FIELD OF THE INVENTION

The present invention relates to information processing. More particularly, the present invention relates to an computerized system and method for reviewing electronic medical records.

### BACKGROUND OF THE INVENTION

Today, medical service providers such as physicians often order diagnostic studies without thoroughly or accurately specifying the reasons (i.e., symptoms or indications) for ordering those diagnostic studies. For instance, a chest CT might be ordered for a “follow up,” but no specific symptoms or indications might be included in the order.

The physician who receives this order to perform the requested diagnostic study must document the results of the diagnostic study, and should include the proper information in the documentation to ensure accuracy and compliance with current insurance reimbursement procedures—assuming, of course, that the physician and hospital want to get paid for the work they have done to perform and evaluate the requested diagnostic study.

Once the study has been performed and evaluated, the report is returned to the physician who placed the initial order, and copies of the report are sent to the appropriate billing department or department for coding. In many cases the claim for reimbursement must be supported wholly by the report received from the physician who performed the diagnostic study.

The billing department generates a claim for reimbursement by assigning codes to the services that were performed, based on the reports received from the physician who performed the diagnostic study. These codes are established and managed by various organizations and can change frequently. Example coding systems include codes used for symptoms and indications, such as the ICD-9 (or ICD-10) codes established and managed by the World Health Organization (WHO), or codes used for procedures, sue has the CPT codes established and managed by the American Medical Association (AMA).

In order to receive proper payment or reimbursement for the services performed, the codes must be applied accurately, and the services performed (i.e., the procedures coded by the CPT codes, for instance) must be appropriate for the noted indications (i.e., the symptoms and indications coded by the ICD-9 codes, for instance). The medical necessity and associated qualifications for payment and reimbursement are determined by organizations like the Centers for Medicare and Medicaid Services (CMS) or various 3rd-party healthcare insurance companies.

### SUMMARY OF THE INVENTION

Disclosed herein are a system and method for computerized medical records review. The system includes a computerized report engine that includes a draft diagnostic report (which may include interpretation of a diagnostic study on a patient), and a computerized draft analyzer for automatically reviewing the draft diagnostic report for report inadequacies and for displaying the results of the automatic review.

The method disclosed herein includes using a computer to automatically identify a report inadequacy in the draft diagnostic report, flagging the report inadequacy, and recommending a correction of the report inadequacy. The review may also encompass other electronic medical records. Another embodiment of the method disclosed herein comprises using a computer to automatically review a draft diagnostic report for one or more substantive inadequacies and displaying the results of the automatic review prior to finalization of the draft diagnostic report.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 shows an exemplary workflow in an embodiment.

FIG. 2 shows a flow diagram for an exemplary computerized method for reviewing electronic medical records.

FIG. 3 shows an exemplary display of a computerized system and method for reviewing electronic medical records.

FIG. 4 shows components of an exemplary electronic medical records review system.

### DETAILED DESCRIPTION OF THE INVENTION

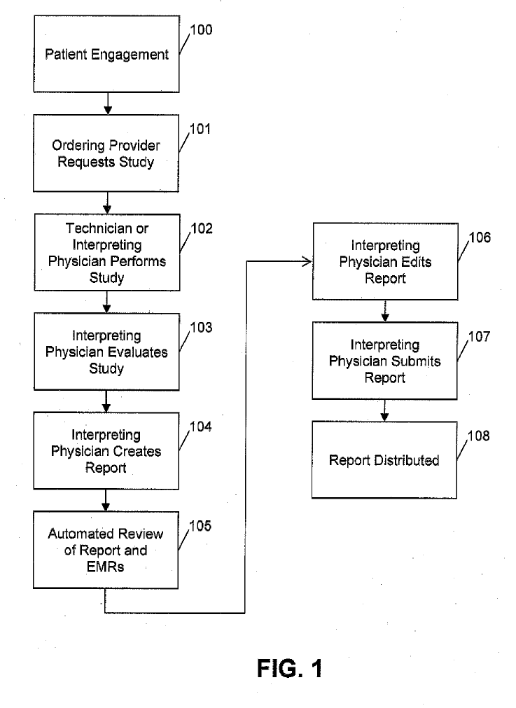

FIG. 1 shows the workflow in an embodiment of the invention. The process begins at step 100 when the patient meets with the physician. For purposes of clarity, this physician will be referred to as the Ordering Provider (which may, for instance, also include nurse practitioners, physician assistants, dentists, or chiropractors, to name a few). If the Ordering Provider determines that some form of diagnostic study (which may include one or more diagnostic studies or procedures) is required, the Ordering Provider will place an order for the diagnostic study at step 101. This order can be written by hand, entered into a hospital information system (HIS) or, for radiological diagnostic studies, a radiology information system (RIS,), or entered into a computerized physician order entry system (CPOE).

Exemplary diagnostic studies include chest x-rays and CT scans (in radiology), EKGs and echocardiograms (in cardiology), and fine needle aspiration and Pap smear (in pathology).

At the time of order, the Ordering Provider can document the motivation for the diagnostic study. Using radiology studies as an example, typical motivations might include any of the following: “head pain” or “dizziness” (for a CT scan), or “chronic cough,” “follow-up,” or even “rule out pneumonia” (for a chest X-ray).

The ordered diagnostic study is then performed on the patient at step 102. For a radiology study, such as a chest X-ray, a Technician performs the study. The chest X-ray images are typically maintained in a picture archiving communication system (PACS), though several facilities still use hardcopy films, stored in jackets or folders, that are viewed by the radiologist on a lightbox. The Technician may document any notes from the imaging session (such as “patient movement caused blurred image” or “patient complained of pain during session”) into the PACS or RIS.

Once the diagnostic study has been performed, a physician must interpret the results of the study at step 103. For purposes of clarity, this physician will be referred to as the Interpreting Physician, though in some fields (such as cardiology) the Ordering Provider and the Interpreting Physician may be the same person. In the case of radiology studies, the Interpreting Physician (a radiologist) would view the images of the diagnostic study on the PACS workstation or in hardcopy form on a viewbox. At step 104, the Interpreting Physician would document the interpretation of the study, either using a voice-recognition (VR) system (such as offered by Nuance Communications) or through a dictation system (such as the Dictaphone system, also offered by Nuance Communications). After using either VR or dictation, the Interpreting Physician's interpretation of the study would be converted into text format. Interpretations might also be manually typed or completed with the aid of a pre-formatted template.

Prior to the submission (or “sign off”) of the interpretation by the Interpreting Physician, the diagnostic study (or diagnostic report) is in draft form, and the diagnostic study is finalized only after submission or “sign off” by the Interpreting Physician. Preferably the draft diagnostic study is analyzed at step 105 for report inadequacies. In an embodiment, other documents, preferably relating to the patient (for instance, any electronic medical records for the patient during the past 180 days, or some other appropriate period of time), also may be analyzed to identify report inadequacies. Preferably the analysis of the draft diagnostic study and the other documents is performed automatically.

A draft diagnostic report (or study) may be inadequate (or substantively inadequate) in several different ways. For example, a diagnostic report is inadequate if it does not accurately describe the actions taken or findings made by the Interpreting Physician. Sometimes this can occur through transcription error. For example, if the Interpreting Physician dictates “no evidence is found of head bleeding” but the draft report generated by the voice recognition system drops the “no” and produces the phrase “evidence is found of head bleeding,” the diagnostic report would be inaccurate and inadequate. Another source of report inadequacy arises from failure to completely comply with the requirements for documenting a diagnostic study for reimbursement purposes. In an embodiment, any type of error in the draft diagnostic study that could diminish or impede reimbursement (or improperly overcharge) would be considered a reimbursement or report inadequacy. Exemplary reimbursement inadequacies include, for example, discrepancies, items of non-compliance, incompleteness, or inaccuracies in the interpretation. The method and system disclosed herein are designed to flag or otherwise note any report or reimbursement inadequacies when the draft diagnostic report is displayed to the Interpreting Physician prior to sign off and submission. Preferably, recommendations also are provided at this time for possible corrective action.

Here are a few examples, from typical radiology studies, of notes and recommendations that might in an embodiment be displayed to the Interpreting Physician:
For PA and lateral chest x-ray: “Number of views not specified. Current report will default to single view study. Please note the number of views in the study.”
For chest x-ray: “No reimbursable indication identified. Records show patient had pneumonia. Was pneumonia an indication for this study?”
For CT scan: “No reimbursable indication identified. Complaint of ‘pain’ noted in Nurse's note. Was pain an indication for this study?”
For CT scan: “Use of intravenous contrast not documented in report. Please document if appropriate.”
For ultrasound-guided biopsy: “Use of imaging-guidance not stated in report. If appropriate, please document use of imaging-guidance.”
For carotid ultrasound: “‘Dizziness’ is not a reimbursable indication for this study. Were any of the following related terms an indication for this study? vertigo, stenosis, vision loss . . . ”
For chest x-ray: “Current and prior studies were performed on same date. Times of both studies must also be specified.”
For abdominal ultrasound: “IVC patency must be reported for ‘complete’ abdominal ultrasound exam. Current report may only qualify for ‘limited’ exam.”

An embodiment preferably can display the appropriate or likely reimbursement amount for the diagnostic study, displaying the initial reimbursement amount (prior to any edits or corrections that might be made by the Interpreting Physician) and the potential reimbursement amount (assuming the appropriate edits or corrections are made by the Interpreting Physician) or the difference between the two amounts, or simply the potential reimbursement loss arising from the inadequacies in the draft report. The amount of the potential reimbursement loss may vary depending on the insurance associated with the particular patient. An embodiment can express the potential loss with reference to the reimbursement amounts provided by Medicare or other common insurer

After viewing the notes and recommendations made by the present invention, at step 106 the Interpreting Physician can edit or revise the draft report or study, as appropriate, or leave the draft study unchanged. The revisions or edits will be processed, and the Interpreting Physician would then sign off and submit the final report at step 107.

At step 108, the results of the diagnostic study might be delivered to several recipients, typically through the HIS (or RIS, in the case of radiology studies). Recipients might include the Ordering Provider, the Interpreting Physician, the hospital or imaging center's billing department, and the Interpreting Physician's billing department. Upon receiving the report from the diagnostic study, the Ordering Provider might determine the next appropriate course of action. Preferably one or more reimbursement claims are created based on the content of the final diagnostic report.

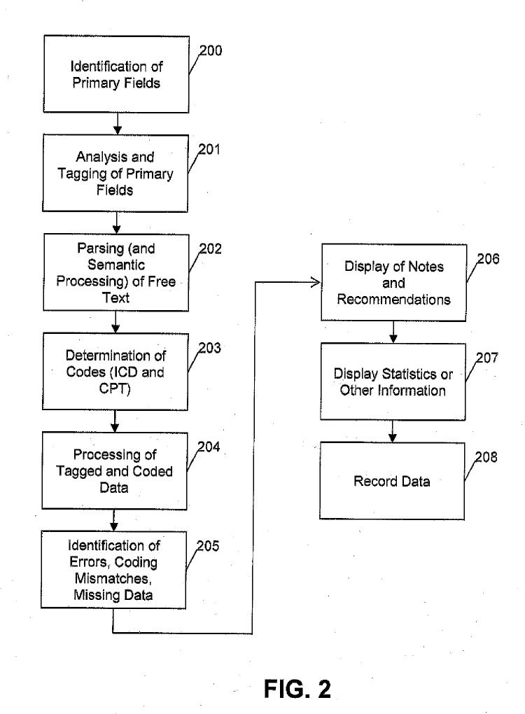

The embodiments of a method and system disclosed herein disclose use of a computer to review and analyze a draft diagnostic report to identify potential report inadequacies. In embodiments, the draft diagnostic report is analyzed in conjunction with other medical records. To analyze the text of the Interpreting Physician's draft diagnostic report, (where such text might be generated by voice recognition system, dictation, or even manual typing), an embodiment preferably follows the process shown in FIG. 2. At step 200, the primary fields of the text report are identified. Exemplary fields preferably include: patient's name, patient identification number, date of birth, date of diagnostic study, time of diagnostic study, patient history, findings, or overall impression from the study. Primary fields might be identified using analysis of text characters or delineators (e.g., spaces, tabs, carriage returns) and/or the identification of specific words or phrases (e.g., “Name:”).

After the text is separated into the primary fields, each primary field section might be analyzed and tagged at step 201 by any means known to one of ordinary skill in the art, including publicly available natural language parsers and/or taggers. For instance, the text appearing in a “Name” field might be tagged as Patient Name, and the text appearing in a “Patient ID” field might be tagged as Patient ID. Text in a field such as “Clinical History,” “Impression,” or “Findings” might be free-form text and may need to be parsed and tagged (and possibly analyzed by a semantic processor or a business rules engine) at step 202. Other fields might include “Study Type,” “Comparison Study,” “Comparison Study Date,” or “Technique.”

One of the analyses that might be performed at step 203 is the determination of ICD-9 (or ICD-10) codes from fields within the report (typically, the “Clinical History” field and the “Findings” field, though indications, symptoms, or diagnoses might appear in other fields as well). Such a determination could be made using a business rules engine to analyze the parsed and tagged Clinical History text. An example business rule might be “‘Dizziness’ and ‘giddiness’ are included in ICD-9 code 780.4” or “‘Headache’ and ‘facial pain’ and ‘pain in head’ are included in ICD-9 code 784.0.”

Another analysis that might be performed at step 203 is the determination of CPT codes from fields within the report (typically, the “Study Type” field). Such a determination could be made using a business rules engine to analyze the parsed and tagged Study Type text. An example business rule might be “‘Chest x-ray, 2 views’ and ‘Radiologic examination, chest, two views, frontal and lateral’ are included in CPT code 71020.”

Similarly, an embodiment might analyze other documents or records, including, preferably, electronic medical records (EMRs), typically from a recent range of dates corresponding to the date of the diagnostic study. Each appropriate EMR may be pulled from the HIS or and its text analyzed and as described above. For instance, the primary fields of each EMR might be identified, the text within each field would be analyzed and tagged, and any free-form text might be processed, analyzed and tagged as appropriate. For example, if no reimbursable indication is found in the draft diagnostic report, the patient's EMR can be searched to identify reimbursable indications, e.g., a diagnosis of pneumonia in the EMR may be an indication for a chest x-ray, or a nurse's note of “pain” may be an indication for a CT scan.

Metadata, relating to EMR also may be collected for use in the analysis. For example, if the diagnostic study includes review of images from a PACS, metadata from the PACS may be used to identify the number of images, which could be relevant to the number of views that should be identified in the diagnostic report.

After the fields and content of the draft diagnostic report and EMR have been analyzed and tagged, in an embodiment a business rules engine (such as the JRules system provided by IBM, or Blaze Advisor by Fair Isaac Corporation) will apply one or more business rules using the tagged data from the Interpreting Physician's draft diagnostic and the appropriate EMRs at step 204 and step 205. The business rules engine would contain updated compliance rules and rules for accuracy (i.e., rules that might compare the content of associated EMRs with the content of the Interpreting Physician's interpretation report).

Here are a few examples, from the field of radiology, of exemplary business rules:
Clinical History should not be blank or contain the phrase “follow up” or “followup” or “rule out.”
If Study Type specifies “views,” Findings or Technique should specify “views.”
CPT codes 71010 through 71020 require ICD-9 code 512.0 through 512.9.
Complete abdominal ultrasound must include comments on liver, gallbladder, pancreas, intrahepatic ducts, common bile duct, spleen, right kidney, left kidney, aorta, IVC in the Findings section.
Contrast-enhanced CT examinations require that the Technique or Findings sections contain the phrase “intravenous contrast” or “intravenous Isovue” or “intravenous Omnipaque.”

After the business rules engine has processed the tagged data and EMR, at step 206 and step 207, the results of such analysis are preferably flagged or displayed to the Interpreting Physician prior to report “sign off” or submission. An embodiment also displays notes and recommendations proposing possible corrective action to remedy any inadequacies. Notes and recommendations could be displayed inline with the original text of the interpretation, or in a sidebar next to the original text, or in a separate pop-up or fly-out window. Any notes and recommendations that are not noted inline with the original text might refer to highlight markers (or other markers) that might be placed within or near the original text at appropriate points.

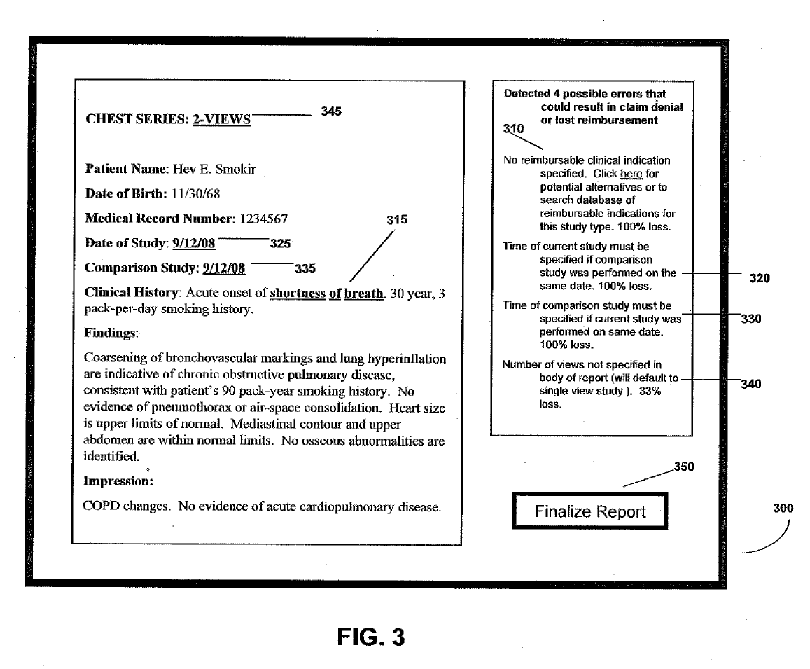

A sample report 300 with notes and recommendations appears in FIG. 3. Note 310 identifies an inadequate description of a reimbursable clinical indication 315 and flags a potential loss of 100% of the available reimbursement due to the inadequate description. Note 310 provides access (via hyperlink) to alternative indications and a database of reimbursable indications for the study type. Notes 320 and 330 alert the Interpreting Physician of the risk of 100% reimbursement loss if the report fails to specify the time of a study and comparison study performed on the same day (325, 335). Note 340 flags the fact that the body of the report does not specify the same number of views identified in the title of the report 345, thereby leading to a potential loss of 33% of reimbursable income. FIG. 3 also shows button 350 which the Interpreting Physician uses to finalize the draft report when he or she is satisfied with the content.

The embodiments disclosed herein preferably identify or flag inadequacies for correction prior to completion of the diagnostic report, and thus are different from “computer-assisted coders” or “claim scrubbers” that which can be used by billing/coding departments after the report of the diagnostic study has been signed off or finalized by the Interpreting Physician. After the report has been finalized, the Interpreting Physician has limited time and ability to edit the report should compliance errors be detected. For example, it may take the Interpreting Physician 10 minutes to remedy a reimbursement inadequacy in a final report, whereas the same problem would have taken 20 seconds to fix had it been brought to the attention of the Interpreting Physician prior to submission of the draft diagnostic report. The embodiments described herein can detect additional errors beyond non-matching ICD9-CPT pairs, and can provide recommendations regarding how these errors could be corrected to minimize reimbursement loss.

At step 208 an embodiment preferably stores and/or retains information from the report analysis, as well as any actions taken or edits made by the Interpreting Physician. This stored information is available for report generation, statistical analysis, or logging and auditing purposes.

An alternate embodiment analyzes the draft diagnostic report during report creation with voice recognition (VR) as each word, phrase, or sentence is spoken by the Interpreting Physician. Possible corrections, suggestions, or edits could be offered or proposed in real-time and selected by the Interpreting Physician using VR or other commands.

Another alternate embodiment performs the described analysis during the Ordering Provider's order creation process, either by analyzing the text of the order or by performing a real-time analysis of an order entered using a voice recognition (VR) system. In this embodiment, notes and recommendations are provided to ensure an accurate and compliant order is entered prior to submission to the Technician or Interpreting Physician. As above, possible corrections, suggestions, or edits are proposed in real-time for selection by the Ordering Provider using VR or other commands.

Embodiments preferably enable or facilitate the ability of the Interpreting Physician to request and receive information during review of the draft diagnostic report. For example, if the Ordering Provider requested a CT scan of the head, cervical spine, chest, abdomen, and pelvis for “trauma,” which might be a non-reimbursable indication, the Interpreting Physician might want to contact the Ordering Provider or the Technician to determine whether the patient was experiencing “pain” (which might be a reimbursable indication) in any/all of these areas, and whether pain or other symptoms were reasons this study was ordered. The Interpreting Physician preferably could contact any other source if any additional information or clarification is appropriate or required.

The present invention could support or facilitate this contact by providing the contact information (such as phone number, email address, or pager number) for the Ordering Provider and/or Technician, and might even enable immediate dialing of the appropriate phone number through an integrated communications link such as a voice-over-internet-protocol (VOIP) communications module, email, or instant messaging. Any additional information provided by the Ordering Provider or Technician during this real-time contact could be noted by the Interpreting Physician, and such communication could be noted and logged by the present invention. This information might be stored in an appropriate database within the present invention. Additionally, the notes and recommendations might provide hyperlinks or other means of accessing remote data stores of relevant information, for example which ICD-9 and CPT codings do or do not support reimbursement for a particular study.

The embodiments disclosed herein preferably use business rules engines at various stages of the process. Without limiting the scope of the invention, several benefits accrue from using a business rules engine. First, the business rules can be abstracted from the programming language and written in easy-to-understand phrases and sentences. Second, the business rules can be easily maintained and updated from time to time as the rules and behavior of the system need to be changed. In the healthcare field, the rules for compliance, in particular, can change on an annual or monthly basis. Using a business rules engine at various stages in the process for the present invention might enable improved updating and flexibility in the rules. For instance, if the original business rule was “CPT codes 71010 through 71020 require ICD-9 code 512.0 through 512.9,” but it was determined that a different range of ICD-9 codes is now required, it would be straightforward to edit the latter part of the rule to reflect the updated range of allowable ICD-9 codes. Further, the business rules engine might be able to track the changes made to the rules, noting who made the changes and when the changes were made. This tracking information might be useful for auditing or reporting purposes.

To the extent that physicians might not be aware of the intricacies of the various coding systems, or do not have the time or resources to keep up with the frequent changes to the coding systems or reimbursement guidelines made by organizations like WHO, AMA, or CMS, the method and system disclosed herein provide an easy-to-use, real-time access to automated services that might provide helpful guidance or notifications of errors, inaccuracies, or non-compliance during the review of the diagnostic study or at the point of care, and prior to submission of the final report.

Embodiments preferably include functionality for the administration of the services, customization of the services, and reporting. This functionality might be provided through a website or might be accessed through an application installed on a client workstation.

Administrative functionality might include:
The ability to create a group account, such a group account to include at least one, but probably multiple, individual user accounts. The group account might include the group name, group address, group administrator information, group payment information, and other information relevant at the group level.
The ability to create, edit, manage, delete, or archive individual user accounts. An individual user account might include the user's name, title, healthcare specialty, mailing address, email address, phone number, login name, login password, and security access privileges (for instance, the user might be an administrator, a power user, or a regular user). A user account might also contain the stored customized user preferences that are specified by the user to customize his or her individual account, including default behavior of the services or display preferences, for instance.
The ability to specify insurance payer profiles, or to create, edit, delete customized business engine rules.
The ability to specify different thresholds or settings to control the behavior of the services. For instance, an administrator could set a threshold stating that only studies having a potential reimbursement value above $100.00, or some other amount, should be reviewed by the system. Other settings might include specifying which fields to review, which study types to review, and which date ranges of EMRs to review.

In an embodiment administrators and users can request certain reports be generated and displayed for review. These reports might provide useful information on the management and use of the embodiments disclosed herein, the change in accuracy and compliance of the Interpreting Physicians, and the statistics of the diagnostic studies. Preferably the reports include data from its own database, or from external sources of information (such as the HIS, RIS, PACS, or 3rd-party billing/coding systems).

Example reports regarding correction of report inadequacies include:
A report showing which Ordering Providers are not providing useful/accurate/compliant/reimbursable histories.
A report showing which Interpreting Physicians are submitting reports with errors that are not accurate or are non-compliant. Such report could include, in the case of errors leading to lost reimbursement, the total amount of lost reimbursement associated with specific Interpreting. Physicians.
A report showing the total potential lost reimbursement recovery, by study type, Ordering Provider, Interpreting Physician, healthcare facility, or specific time period.
A report showing which studies contain the most errors, inaccuracies, or non-compliant issues.
A report showing the most common errors or issues.
A report showing the work flow time, which would provide insight into how much time, if any, the present invention is adding to the total work flow process. This report might also be customized by study type, Ordering Physician, Interpreting Physician, healthcare facility, or specific time period. This report (or some variation of this report) might also show the ratio of lost reimbursement per time spent correcting errors for every type of study performed. Such a report might enable the targeting of only those studies with ratios above a certain customizable threshold.

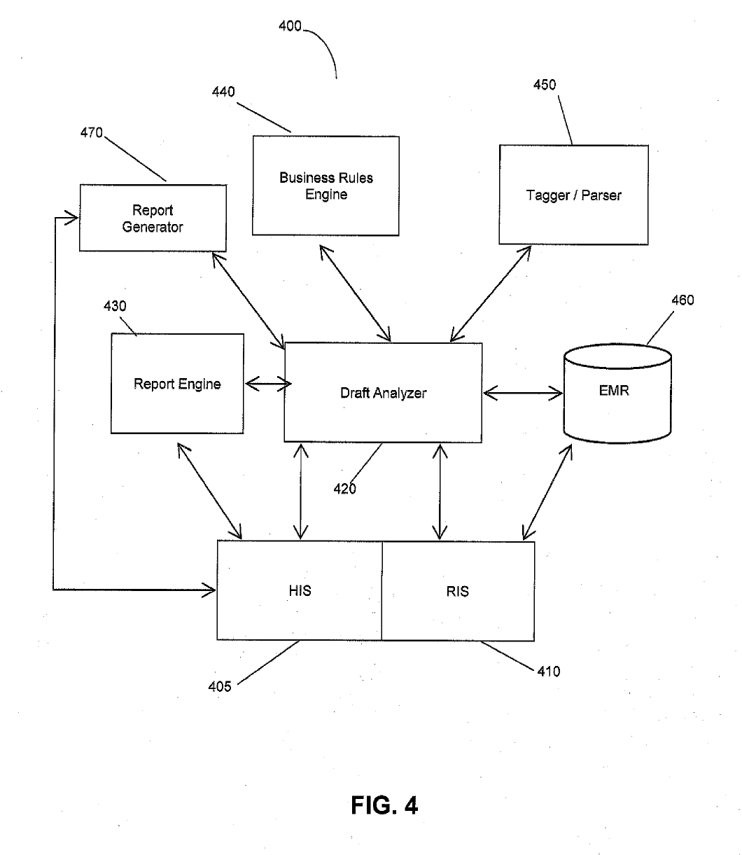

FIG. 4 is a block diagram illustrating components of an exemplary electronic medical records review system 400 in accordance with this invention.

An embodiment of medical records review system 400 preferably includes an HIS (Hospital Information System) 405 and/or Radiology Information System (RIS) 410. Exemplary Information Systems are available from McKesson, Meditech, Epic and Cerner. Also included in the exemplary electronic medical records review system is a data store 460 for electronic medical records. Data store 460 may be integrated with HIS 405 and/or RIS 410. Alternatively data store 460 may be directly or indirectly coupled, locally or remotely, to HIS 405 and/or RIS 410.

Also included in the exemplary electronic medical records review system 400 is Report Engine 430. In an embodiment Report Engine 430 comprises dictation and voice recognition functionality, such as are provided by the PowerScribe products provided by Nuance Communications. Preferably Report Engine 430 will enable the Interpreting Physician to prepare a draft diagnostic report (through, for example, dictation and voice transcription, or typing) and to review the draft diagnostic report before signing off. Report engine 430 may be integrated with or, another embodiment, coupled to HIS 405 or RIS 410.

Also included in the exemplary electronic medical records review system 400 is Draft Analyzer 420, which preferably is coupled to Report Engine 430, EMR data store 460, and HIS 405/RIS 410. In an embodiment, Draft Analyzer 420 performs the methods described herein (for example, in FIGS. 1 and 2), including automatically reviewing and analyzing the draft diagnostic report and other EMR to identify report inadequacies, flagging the inadequacies, and proposing corrective action. Draft Analyzer 420 comprises Business Rules Engine 440 and Tagger/Parser 450. Exemplary business rules engines include the Mules system provided by IBM, or Blaze Advisor by Fair Isaac Corporation. Alternatively, business rules engine 440 may be provided by HIS 405 or RIS 410. Also included is Report Generator 470 which handles the data gathering and report generation for the reports described above, including the reports regarding correction of report inadequacies.

In an embodiment, the components of the exemplary electronic medical records review system 400 are implemented in software that is executed by one or more computer systems although other implementations are within the scope of the invention such as implementing all or part of the system on a hardware device or a combination of hardware and software. The components of the exemplary electronic medical records review system may be implemented on a variety of computer architectures (for example, standalone workstation connected to a network, a client/server type architecture, a mainframe system with terminals, an ASP model, a peer to peer model, and the like) and networks (for example, a local area network, the internet, a telephone network, a wireless network, a mobile phone network, and the like), and those other implementations of the medical records review system are within the scope of the invention since the invention is not limited to any particular computer architecture or network.

The components of the exemplary electronic medical records review system 400 preferably are implemented on any device with sufficient computing power, memory and connectivity to be able to execute the methods disclosed herein, including one or more processing units, a persistent storage unit and a memory that stores the pieces of software being executed by the processing unit or units. The components of the exemplary electronic medical records review system preferably are implemented in a plurality of lines of computer code that perform the steps of the methods described herein.

Those of skill in the art will readily recognize that any form of display and input device may be used to advantage in the method and system disclosed herein, including but not limited to conventional monitors, a PDA or handheld device, imaging workstation, keyboard, trackball or other pointing device, microphone, and the like.

In an embodiment, some components or modules of the present invention might be installed on the Interpreting Physician's client workstation (or, alternatively, an Ordering Provider's client workstation) and integrated with the appropriate applications running on such workstation (including, for instance, the RIS, HIS, CPOE, and/or PACS), and other components or modules of the present invention might be hosted on a separate system (which might include multiple servers serving different functions) and accessed through the Internet or other network. Specifically, the business rules engines (including the up-to-date business rules) might be hosted on business rules engines servers located in a central location and accessed by multiple client workstations via the Internet or other network. On the other hand, the parsing and tagging modules, which analyze the report and EMRs on the client workstation (or client's computer network), might be installed on the client workstation and, further, integrated with the applications running on that client workstation or client network. Tagged data identified by these tagging and parsing modules at the client workstation might be transmitted via the Internet or other network to the processing functions hosted at the central system (including any databases, semantic processors, and business rules engines). The notes and recommendations developed during this processing preferably are transmitted back to the client workstation for formatting and display.

In another embodiment, the portions of the present invention installed on the Interpreting Physician's client workstation might not be tightly integrated with the Interpreting Physician's applications (such as HIS, RIS, and PACS). Rather, the embodiment might have a module that can scan and “grab” (or “screen scrape”) the appropriate text of the report to be analyzed. Alternatively, the Interpreting Physician might copy the relevant text onto the client workstation's operating system's “clipboard,” and a module of the present invention might register the collection of this relevant text in the clipboard, then analyze the relevant text contained in the clipboard. Since this configuration would not be well-integrated with the applications on the client workstation, the notes and recommendations might be displayed in a separate pop-up window for the Interpreting Physician.

In yet another embodiment, the functionality of the present invention might be accessed entirely through the Internet or other network, via a web browser on the Interpreting Physician's client workstation or other workstation. When the Interpreting Physician is presented with the transcribed report to review, the text of the report might be copied and pasted into the appropriate field of the present invention's website. After analysis and processing of the text of the report, any notes and recommendations might be displayed in the website.

An embodiment may include a website that provides limited functionality related to the compliant matching of ICD-9 (or ICD-10) codes and CPT codes. The website might first request that the Interpreting Physician enter the name of the diagnostic study. Entry of the name of the diagnostic study might be facilitated by a form of an automatic completion pick-list. As the Interpreting Physician begins typing the first letters of the name of the diagnostic study, the website might display a list of diagnostic studies all of which include the letters that are being typed. As the Interpreting Physician types in more letters, the list will become more specific and shorter. At any point, when the Interpreting Physician sees the name of the current study, he or she can click on that study name. If the Interpreting Physician types in the name of the study and this study name is not recognized by the present invention as being associated with a known CPT code, the Interpreting Physician will then be directed to a menu tree through which the name of the study can be searched.

For example, a typical diagnostic study in the field of radiology is the chest x-ray. As the Interpreting Physician begins typing the word “chest,” a list of diagnostic studies beginning with the letter c will appear. This initial list might be sorted either alphabetically or in order of frequency of use. After the Interpreting Physician types the letter h, only those diagnostic studies containing the character set “ch” will appear. Again, this list might be sorted alphabetically or in some other order. This process continues until the Interpreting Physician selects one of the studies in the list or until no matching studies appear in the list.

Once the study name is selected, the website might request that the Interpreting Physician type in the name of the study indication. Example indications include “dyspnea” or “vertigo” (in radiology), and “breast calcifications” or “lymphadenopathy” (in pathology). As the Interpreting Physician begins typing in the first letters of the study indication, the application will display a list of indications that include those letters and are known to be reimbursable indications for the type of study specified earlier. As the Interpreting Physician types in more letters, the list will become more specific and shorter. At any point, when the Interpreting Physician sees that the given indication is included in the list of reimbursable indications, then he or she has verification that the given indication is considered a compliant and reimbursable indication for the given study type. If the Interpreting Physician types in the name of the indication and the name is not recognized by the present invention as a reimbursable indication for this study type, the Interpreting Physician will be presented with a navigable list of all reimbursable indications for this study type. The present invention may also suggest specific reimbursable indications that are synonyms of the indication typed, e.g. the website may present “vertigo” as a reimbursable alternative if the Interpreting Physician types in “dizziness” and finds that it is not included in the list of reimbursable indications for given type of study.

The website configuration of an embodiment could be used by anyone along the workflow process, including the Ordering Provider, scheduling staff, the Technologist, Interpreting Physician, or the coder/biller.

Further, this website configuration might include advertising and/or a paid subscription-based user account (or healthcare practice account) revenue model. Additional functionality might include a set of forums that would enable users to post questions or comments and respond to questions and comments. Experts and moderators might contribute articles or answers to the website content. Users might be able to create personal accounts, then customize the behavior of the website's services (for instance, displaying only radiological services and information is the user is a radiologist, or displaying only information and services related to pathology if the user is a pathologist). A group administrator might be able to create a group account, with functionality similar or identical to the group functionality described above.

For each of these configurations and embodiments, the present invention might use standard PC-based servers, running Microsoft operating system, programmed in languages such as Microsoft .Net, Peri, ActiveX controls, Active Server Pages, and AJAX, using databases such as Microsoft SQL Server or MySQL, and business rules engines such as IBM's Mules or Fair Isaac's Blaze Advisor. The website associated with the present invention might be viewed using web browsers such as Microsoft's Internet Explorer or Mozilla's Firefox.

While the foregoing written description of the invention enables one of ordinary skill to make and use what is considered presently to be the best mode thereof, those of ordinary skill will understand and appreciate the existence of variations, combinations, and equivalents of the specific embodiment, system, method, and examples herein. The invention should therefore not be limited by the above described embodiment, system, method, and examples, but by all embodiments, systems, and methods within the scope and spirit of the invention as claimed.

We claim:

1. A system for computerized medical records review, comprising:
a computerized report engine comprising a draft diagnostic report, the draft diagnostic report comprising interpretation of a diagnostic study on a patient; and
a computerized draft analyzer for automatically reviewing the draft diagnostic report for report inadequacies and for displaying the results of the automatic review.

2. The system of claim 1 wherein the computerized draft analyzer is coupled to a business rules engine.

3. The system of claim 2 wherein the business rules engine is updated from time to time.

4. The system of claim 1 further comprising a datastore comprising one or more electronic medical records relating to the patient.

5. The system of claim 1 wherein the computerized draft analyzer is operative to flag a report inadequacy in the draft diagnostic report.

6. The system of claim 5 wherein the computerized report monitor is operative to process a correction of a report inadequacy in the draft diagnostic report.

7. The system of claim 6 further comprising a report generator that produces reports regarding correction of report inadequacies.

8. The system of claim 1 further comprising a Web site coupled to the computerized draft analyzer, the Web site operative to respond to requests for reimbursement information.

9. A method of computerized medical records review, comprising:
using a computer to automatically identify a report inadequacy in a draft diagnostic report, the draft diagnostic report comprising interpretation of a diagnostic study on a patient;
flagging the report inadequacy in the draft diagnostic report; and recommending a correction of the report inadequacy.

10. The method of claim 9 further comprising finalizing the draft diagnostic report.

11. The method of claim 9 wherein a business rules engine is used to automatically identify the report inadequacy.

12. The method of claim 11 wherein automatically identifying the report inadequacy further comprises analyzing an electronic medical record related to the patient.

13. The method of claim 9 further comprising interactively requesting and receiving information prior to finalization of the draft diagnostic report.

14. The method of claim 9 wherein flagging the report inadequacy comprises displaying potential lost reimbursement revenue.

15. The method of claim 9 further comprising producing a report regarding correction of report inadequacies.

16. A method of computerized medical records review, comprising:
using a computer to automatically review a draft diagnostic report for one or more substantive inadequacies, the draft diagnostic report comprising interpretation of a diagnostic study on a patient; and
displaying the results of the automatic review prior to finalization of the draft diagnostic report.

17. The method of claim 16 wherein the results of the automatic review indicate no substantive inadequacies.

18. The method of claim 16 wherein the results of the automatic review comprise a transcription error.

19. The method of claim 16 wherein the results of the automatic review comprise a reimbursement inadequacy.

20. The method of claim 16 further comprising recommending a proposed correction of a substantive inadequacy in the draft diagnostic report before finalization.
